(19) United States
(12) Patent Application Publication
(10) Pub. No.: US 2021/0333915 A1
(43) Pub. Date: Oct. 28, 2021

(54) INFRARED TOUCH DISPLAY AND MANUFACTURING METHOD THEREOF

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Mingjun ZHOU, Shenzhen, Guangdong (CN)

(73) Assignee: SHENZHEN CHINA STAR OPTOELECTRONICS SEMICONDUCTOR DISPLAY TECHNOLOGY CO., LTD., Shenzhen, Guangdong (CN)

(21) Appl. No.: 16/620,157

(22) PCT Filed: Oct. 30, 2019
(86) PCT No.: PCT/CN2019/114488

§ 371 Date: Dec. 6, 2019

(30) Foreign Application Priority Data
Jul. 1, 2019 (CN) 201910583664.8

(51) Int. Cl. G06F 3/041; G06F 3/042; B32B 7/12; B32B 37/12

(52) U.S. Cl. CPC G06F 3/0412; G06F 3/042; B32B 7/12; B32B 2037/1215; B32B 37/1292; B32B 2457/208; G06F 2203/04103; B32B 37/1207

(57) ABSTRACT

An infrared touch display and a manufacturing method thereof are provided. A high-adhesive adhesive layer is pre-attached to a lower surface of a cover to prevent a narrow adhesive stripe made of an optical adhesive from being misaligned or falling off when it is attached to the cover. A small amount of the optical adhesive is used to make the cover and the display panel fit closely to achieve a vacuum attaching, which saves a lot of optical adhesive materials and reduces production costs. Also, a signal transmission performance of an infrared touch panel is further enhanced.

### FIELD OF DISCLOSURE

The present disclosure relates to the field of display technologies, and in particular to an infrared touch display and a manufacturing method thereof.

### BACKGROUND

Touch technologies are important link in a process of human-computer interaction. Display devices such as smartphones and tablets require the touch technologies. Existing touch technologies mainly include a capacitive type, a resistive type, an ultrasonic type, and an infrared type. Both the capacitive and the resistive touch technologies have their best use environment. In an abnormal environment, such as strong electromagnetic interference, it will affect the use of these two touch technologies, resulting in false positives. In contrast, the infrared touch technology has high stability, has strong resistance to external electromagnetic wave interference, is easy to achieve large size, and has long lifespan. Therefore, the infrared touch technology is gradually favored by people.

In the prior art, an infrared touch display includes an infrared touch panel, a glass cover, and a display panel. An existing attaching process of the infrared touch display is generally as follows. The glass cover (CG) is firstly attached to the display panel, and then the infrared touch panel (IR touch panel) is disposed on the glass cover. In general, the glass cover is directed laminated with the display panel, or the both are attached by using an optical adhesive (solid optically clear adhesive) through a direct bonding technology or an air bonding technology. There is a security risk in the direct lamination method. The touch display device that is bonded by the air bonding technology has lower cost than the touch display device that is bonded by the direct bonding technology. A main implementation manner of the existing infrared touch panel is that an infrared emitter and an infrared receiver are arranged on an outer frame of the glass cover, and an infrared receiving network is formed in the glass cover, that is, a dense infrared matrix arranged in vertical and horizontal directions. A touch-operated object (e.g., a finger) can change infrared rays at a touch position, and the infrared receiver scans whether the received infrared rays are blocked to locate the touch position.

Please refer to FIG. 1, which is a schematic diagram of a layer structure of an infrared touch display in the prior art. A glass cover 12 is attached to a display panel 11 by using an optical adhesive 19 through an air adhesive technology, and then an infrared touch panel 13 is disposed on the glass cover 12. The infrared touch panel 13 includes an infrared emitter 131 and an infrared receiver 132 disposed at opposite edges of the glass cover 12. When implementing a narrow bezel design, a surface area of the glass cover 12 is generally greater than a surface area of the display panel 11. Since the optical adhesive 19 has extremely low adhesion, the infrared touch display that is bonded by the air bonding technology is used. When the optical adhesive 19 is aligned with and attached to the glass cover 12, if an alignment is not accurate enough, the optical adhesive 19 may be misaligned or falling off. A surface of the glass cover 12 is convex at a touch area of the glass cover 12 corresponding to a frame-attached position. Thus, when the infrared touch panel 13 is attached to the surface of the glass cover 12, a convex portion of the surface of the touch area of the glass cover 12 blocks the signal transmission of the infrared touch panel 13.

### SUMMARY OF DISCLOSURE

In view of the problems of the prior art, an object of the present disclosure is to provide an infrared touch display and a manufacturing method thereof. A small amount of an optical adhesive is used to make a cover and a display panel fit closely to achieve a vacuum attaching, which saves a lot of optical adhesive materials, reduces production costs, and avoids safety hazards and an inaccurate alignment.

In order to achieve the above object, the present disclosure provides an infrared touch display, including a cover, a first adhesive layer, a second adhesive layer, a vacuum chamber, a display panel, and an infrared touch panel. The cover includes a touch area and a non-touch area, and the touch area is located at a middle of the cover and the non-touch area is located at a periphery of the cover. The first adhesive layer is attached to a lower surface of the cover and corresponds to the non-touch area. The first adhesive layer includes a liquid adhesive or a solid adhesive. The second adhesive layer is attached to a lower surface of the first adhesive layer, and the second adhesive layer includes a ring-shaped solid optical adhesive. A width of the second adhesive layer is less than or equal to a width of the first adhesive layer. The vacuum chamber is formed at middle portions of the first adhesive layer and the second adhesive layer. The display panel is attached to a lower surface of the second adhesive layer, and the display panel is disposed corresponding to the middle of the cover. The infrared touch panel is disposed on the non-touch area of an upper surface of the cover.

In order to achieve the above object, the present disclosure further provides an infrared touch display, including a cover, a first adhesive layer, a second adhesive layer, a vacuum chamber, a display panel, and an infrared touch panel. The cover includes a touch area and a non-touch area, and the touch area is located at a middle of the cover and the non-touch area is located at a periphery of the cover. The first adhesive layer is attached to a lower surface of the cover and corresponds to the non-touch area. The second adhesive layer is attached to a lower surface of the first adhesive layer. The vacuum chamber is formed at middle portions of the first adhesive layer and the second adhesive layer. The display panel is attached to a lower surface of the second adhesive layer, and the display panel is disposed corresponding to the middle of the cover. The infrared touch panel is disposed on the non-touch area of an upper surface of the cover.

In order to achieve the above object, the present disclosure further provides a manufacturing method of an infrared touch display, including following steps: providing a cover including a touch area and a non-touch area, where the touch area is located at a middle of the cover and the non-touch area is located at a periphery of the cover; attaching a first adhesive layer to a lower surface of the cover, where the first adhesive layer corresponds to the non-touch area; cutting a solid optical adhesive into an adhesive stripe, and attaching the adhesive stripe to a lower surface of the first adhesive layer; disposing the cover on an upper surface of a display panel such that display panel is disposed corresponding to the middle of the cover, and a lower surface of the adhesive stripe is attached to the upper surface of the display panel; heating the cover and the display panel in a vacuum environment to melt the adhesive stripe; irradiating the cover and the display panel with ultraviolet rays, so that the melted adhesive stripe is cured into a second adhesive layer, and a vacuum chamber is formed at middle portions of the first adhesive layer and the second adhesive layer; and disposing an infrared touch panel on the non-touch area of an upper surface of the cover.

Advantages of the present disclosure are as follow. In the present disclosure, in a process of realizing a narrow bezel, a high-adhesive adhesive layer is pre-attached to the lower surface of the cover to prevent a narrow adhesive stripe made of an optical adhesive from being misaligned or falling off when it is attached to the cover, thereby preventing safety hazards and an inaccurate alignment. A small amount of the optical adhesive is used to make the cover and the display panel fit closely to achieve a vacuum attaching, which saves a lot of optical adhesive materials and reduces production costs. Also, a signal transmission performance of an infrared touch panel is further enhanced, thereby effectively improving a product yield of the display device and enhancing a product competitiveness.

### BRIEF DESCRIPTION OF DRAWINGS

To describe the technical solutions in the embodiments of the disclosure or in the prior art more clearly, the following briefly introduces the accompanying drawings required for describing the embodiments. Apparently, the accompanying drawings in the following description show merely some embodiments of the disclosure, and a person of ordinary skill in the art may still derive other drawings from these accompanying drawings without creative efforts.

FIG. 1 is a schematic diagram of a layer structure of an infrared touch display in the prior art.

FIG. 2 is a schematic diagram of a layer structure of an infrared touch display of an embodiment of the present disclosure.

FIG. 3 is a schematic diagram of an infrared touch panel of an embodiment of the present disclosure.

FIG. 4 is a schematic diagram of a layer structure of an infrared touch display of another embodiment of the present disclosure.

FIG. 5 is a flowchart of a manufacturing method of an infrared touch display of the present disclosure.

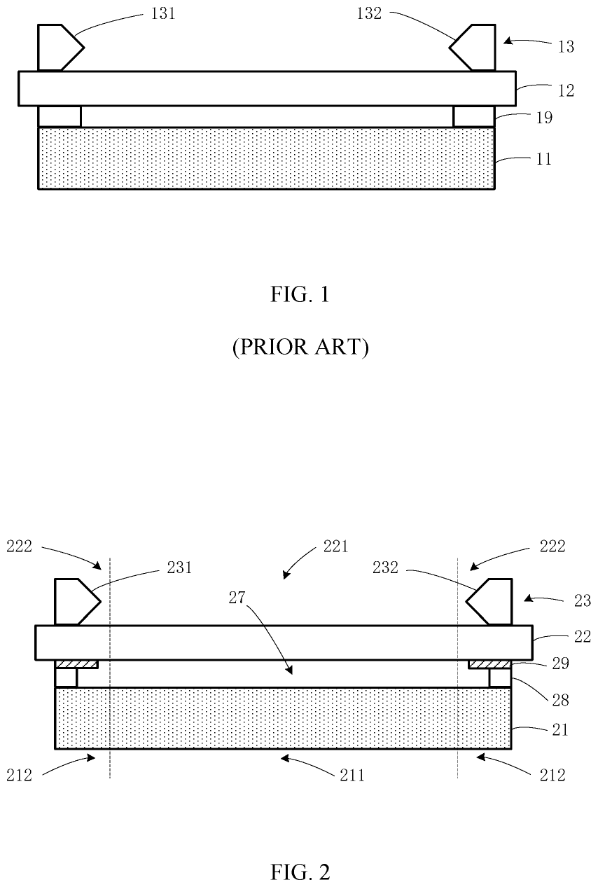

### DETAILED DESCRIPTION

The embodiments of the present disclosure will be described in detail below with reference to the accompanying drawings in which same or similar reference numerals indicate the same or similar elements, or elements with same or similar function. The embodiments described below with reference to the accompanying drawings are exemplary and are merely used to explain the present disclosure, but should not be construed as limiting the present disclosure.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Various embodiments and examples are provided in the following description to implement different structures of the present disclosure. In order to simplify the present disclosure, certain elements and settings will be described. However, these elements and settings are only by way of example and are not intended to limit the present disclosure. In addition, reference numerals may be repeated in different examples in the present disclosure. This repeating is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

Please refer to FIG. 2, which is a schematic diagram of a layer structure of an infrared touch display of an embodiment of the present disclosure. The infrared touch display of the embodiment includes a display panel 21, a cover 22, an infrared touch panel 23, a first adhesive layer 29, a second adhesive layer 28, and a vacuum chamber 27.

The display panel 21 may be a liquid crystal display panel (LCD), an organic light emitting diode (OLED), and an active-matrix organic light emitting diode (AMOLED), quantum-dot light emitting diode (QLED), etc. The display panel 21 is configured to display an image for the infrared touch display. The display panel 21 includes a display area 211 and a non-display area 212. The display area 211 is located at a middle of the display panel 21 and the non-display area 212 is located at a periphery of the display panel 21.

The cover 22 is attached to an upper surface of the display panel 21. The cover 22 includes a touch area 221 located at a middle of the cover 22 and a non-touch area 222 located at a periphery of the cover 22. The cover 22 is configured to protect the display panel 21. A user can directly perform a touch operation applied on the cover 22. In a further embodiment, the cover 22 is preferably a glass cover. Specifically, a surface area of the cover 22 is larger than a surface area of the display panel 21. Since the cover 22 can completely cover the display panel 21, the user's operation on the cover 22 has good sensitivity and it facilitates to realize a narrow bezel design. The display panel 21 is disposed corresponding to the middle of the cover 22, so that it can effectively ensure that the touch area 221 of the cover 22 is consistent with the display area 211 of the display panel 21.

The first adhesive layer 29 is attached to a lower surface of the cover 22 and corresponds to the non-touch area 222. The second adhesive layer 28 is attached to a lower surface of the first adhesive layer 29. The vacuum chamber 27 is formed at middle portions of the first adhesive layer 29 and the second adhesive layer 28. FIG. 2 illustrates a positional relationship of the components. In particular, the middle of the display panel 21 and the middle of the cover 22 are attached to each other under an action of atmospheric pressure by vacuuming and heating to melt an ultraviolet curable adhesive layer. A space occupied by the vacuum chamber 27 is compressed to a minimum, so that the touch area 221 of the cover 22 is recessed, and a signal transmission of the infrared touch panel 23 is effectively ensured.

In a further embodiment, the first adhesive layer 29 is a liquid adhesive or a solid adhesive, as long as the second adhesive layer 28 can be closely attached to the first adhesive layer 29 such that the second adhesive layer 28 is aligned with the first adhesive layer 29. In a further embodiment, the first adhesive layer 29 has a higher adhesion, thereby fixing the second adhesive layer 28 and preventing the second adhesive layer 28 from being misaligned.

In a further embodiment, the second adhesive layer 41 is a solid optical adhesive. The optical adhesive is an ultraviolet (UV) and moisture dual cure optical adhesive that is cured under UV rays. Since a large amount of optical adhesive is required in a direct bonding technology, a manufacturing cost of the panel is greatly improved. Therefore, in this embodiment, an air bonding technology is adopted to effectively save the optical adhesive material. An uncured optical adhesive has very low adhesion, especially when implementing a display panel with a narrow bezel design. If the optical adhesive is directly attached to the cover using the air bonding technology, the optical adhesive will be easily misaligned such that in a process of curing the optical adhesive, the cover and the display panel cannot be closely attached to each other, thereby affecting a quality of the display panel. A cured optical adhesive has excellent weather resistance, especially excellent anti-expansion and anti-explosion properties, which greatly improves a safety, reliability, durability and aesthetics of the display. The optical adhesive has high light transmittance, high attaching strength, low haze, low contraction percentage, and yellowing resistance, and is mainly suitable for medium and large size computers, liquid crystal displays, integrated machines, and the like.

In a further embodiment, a width of the second adhesive layer 28 is less than or equal to a width of the first adhesive layer 29, so that the second adhesive layer 28 is easily attached to the lower surface of the first adhesive layer 29 to preventing the second adhesive layer 28 from being misaligned or falling off.

In a further embodiment, a shape of the second adhesive layer 28 is a ring shape, so that the cover 22 and the display panel 21 can be closely attached. Preferably, a shape of the first adhesive layer 29 is also a ring shape, and the shape of the first adhesive layer 29 is the same as the shape of the second adhesive layer 28, so that the cover 22 and the display panel 21 can be more closely attached during vacuum attaching. Also, it is ensured that the second adhesive layer 28 will not be misaligned or fall off during an attaching process.

In this embodiment, the first adhesive layer 29 and the second adhesive layer 28 need not be disposed in the middle of the cover 22, and the display panel 21 and the cover 22 can still be closely attached. In comparison with the prior art, it can effectively save 60% to 80% of the optical adhesive material, and effectively reduce production costs.

The infrared touch panel 23 includes at least one light emitting unit 231 and at least one light receiving unit 232. The at least one light emitting unit 231 is disposed on the non-touch area 222 of the upper surface of the cover 22 and configured to emit an infrared light. The at least one light receiving unit 232 disposed on the non-touch area 222 of the upper surface of the cover 22 and configured to receive the infrared light. A connection line of the at least one light emitting unit 231 and the at least one light receiving unit 232 passes through the touch area 221.

According to the infrared touch display of the present disclosure, in a process of realizing a narrow bezel, a high-adhesive adhesive layer is pre-attached to the lower surface of the cover to prevent a narrow adhesive stripe made of the optical adhesive from being misaligned or falling off when it is attached to the cover, thereby preventing safety hazards and an inaccurate alignment. A small amount of the optical adhesive is used to make the cover and the display panel fit closely to achieve a vacuum attaching, which saves a lot of optical adhesive materials and reduces production costs. Also, a signal transmission performance of the infrared touch panel is further enhanced, thereby effectively improving a product yield of the display device and enhancing a product competitiveness.

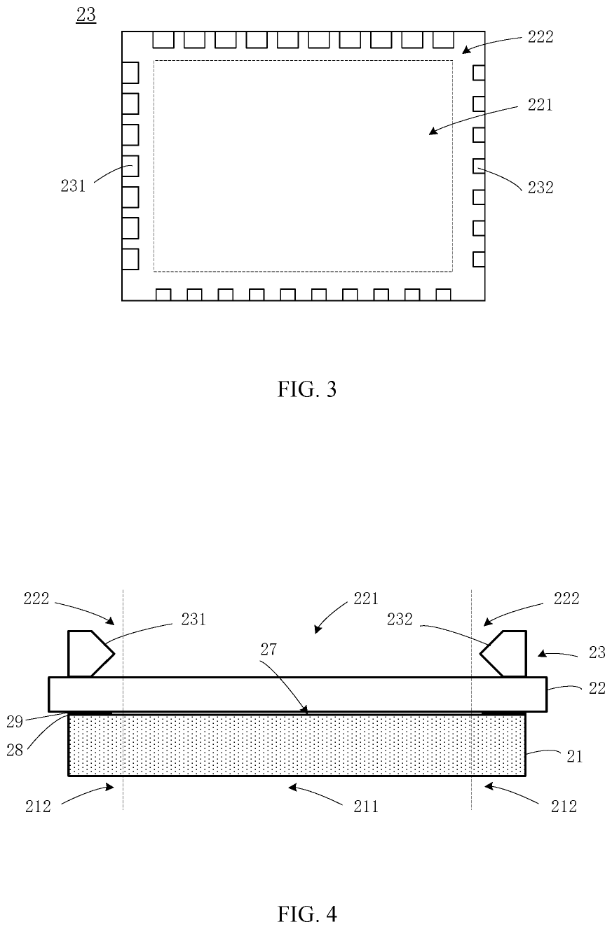

Please refer to FIG. 3, which is a schematic diagram of an infrared touch panel of an embodiment of the present disclosure. In this embodiment, the infrared touch panel 23 includes a plurality of light emitting units 231 and a plurality of light receiving units 232. The plurality of light emitting units 231 are disposed on the non-touch area 222 and disposed at two adjacent edges of the upper surface of the cover 22. The plurality of light receiving units 232 are disposed on the non-touch area 222 and disposed at another two adjacent edges of the upper surface of the cover 22. The plurality of light emitting units 231 and the plurality of light receiving units 232 are arranged in one-to-one correspondence, and a connection line of each light emitting unit 231 and a corresponding light receiving unit 232 passes through the touch area 221.

Specifically, a light emitting surface of the light emitting units 231 is a plane for emitting light including an infrared light toward the touch area 221. The light receiving units 232 are disposed at another edges opposite to the light emitting units 231 for receiving light emitted by the light emitting units 231 and passing through the touch area 221. That is, the connection line of each light emitting unit 231 and the corresponding light receiving unit 232 passes through the touch area 221. The plurality of the light emitting units 231 are arranged in an array with a single column and a single row, and are disposed at two adjacent edges of the upper surface of the cover 22. Correspondingly, the plurality of light receiving units 232 also are arranged in an array with a single column and a single row, and are disposed at another two adjacent edges of the upper surface of the cover 22. The light emitting units 231 and the light receiving units 232 can be implemented by using an existing process equipment. The arrangement may also be implemented by other transmitting and receiving networks that can form light on the cover 22. The present disclosure does not limit this.

Please refer to FIG. 4, which is a schematic diagram of a layer structure of an infrared touch display of another embodiment of the present disclosure. The embodiment of FIG. 4 is different from the embodiment of FIG. 2 in that the adhesive layer is melted and ultraviolet-cured by vacuuming and heating. The middle of the display panel 21 and the middle of the cover 22 are attached to each other under an action of atmospheric pressure, and a space occupied by the vacuum chamber 27 is compressed to a minimum, so that the touch area 221 of the cover 22 is recessed, thereby effectively ensuring a signal transmission of the infrared touch panel 23.

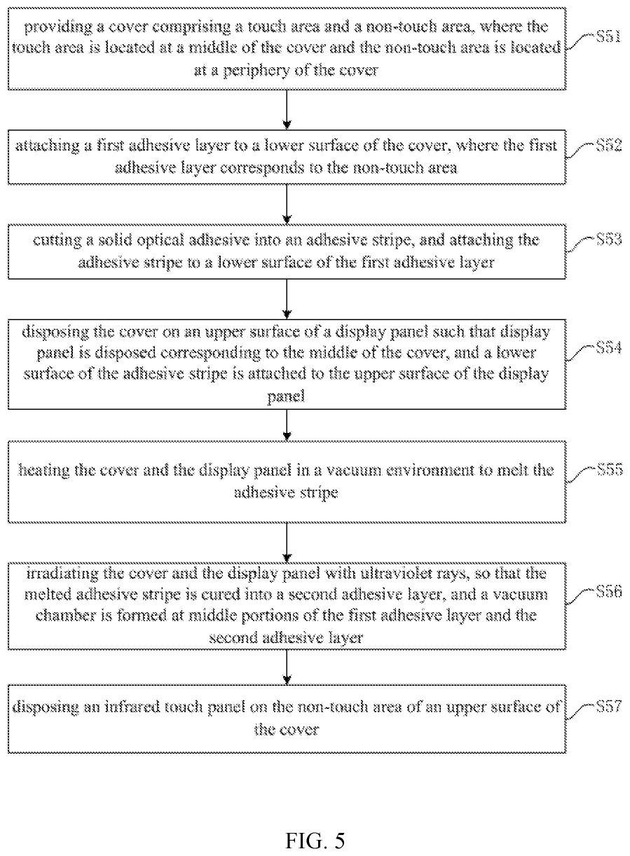

Please refer to FIG. 5, which is a flowchart of a manufacturing method of an infrared touch display of the present disclosure. The method includes the following steps.

In a step S51, a cover is provided. The cover includes a touch area and a non-touch area. The touch area is located at a middle of the cover and the non-touch area is located at a periphery of the cover. The cover is subsequently attached to an upper surface of a display panel for protecting the display panel. A user can perform a touch operation directly on the cover. In a further embodiment, the cover is preferably a glass cover. Specifically, a surface area of the cover is larger than a surface area of the display panel. Since the cover can fully cover the display panel, the user's operation on the cover has good sensitivity and it facilitates an implementation of a narrow bezel design.

In a step S52, a first adhesive layer is attached to a lower surface of the cover. The first adhesive layer corresponds to the non-touch area. The first adhesive layer may be a liquid adhesive or a solid adhesive, as long as the first adhesive layer can be coated or attached to an edge of the lower surface of the cover (corresponding to the non-touch area). The first adhesive layer functions as a pre-fixing and positioning. Preferably, the first adhesive layer is connected end to end, and is prepared for a sequential process, but is not limited thereto. Those skilled in the art can set according to actual needs.

In a step S53, a solid optical adhesive is cut into an adhesive stripe, and the adhesive stripe is attached to a lower surface of the first adhesive layer. A solid optical adhesive can be cut into a narrow adhesive stripe by a die cutting method or a laser cutting method, thereby implementing the display panel with a narrow bezel.

In a further embodiment, the solid optical adhesive may be cut into four adhesive stripes, and then the four adhesive stripes are connected in end-to-end relation to form a ring shape. The ring-shaped adhesive stripes are attached to the lower surface of the first adhesive layer. The four adhesive stripes are connected end to end, and are enclosed in the ring shape, preferably in a annular rectangular shape, but are not limited thereto.

In a step S54, the cover is disposed on an upper surface of a display panel such that display panel is disposed corresponding to the middle of the cover, and a lower surface of the adhesive stripe is attached to the upper surface of the display panel. A charge coupled device (CCD) alignment or a tool auxiliary positioning alignment may be adopted, so that the display panel is disposed corresponding to the middle of the cover. The lower surface of the adhesive stripe is attached to the upper surface of the display panel. Since the surface area of the cover is larger than the surface area of the display panel, the display panel needs to be disposed opposite to the middle of the cover as possible, thereby effectively ensuring that the touch area of the cover is consistent with the display area of the display panel.

In a step S55, the cover and the display panel are heated in a vacuum environment to melt the adhesive stripe.

In a further embodiment, the cover and the display panel can be transfer into a vacuum device, and then the vacuum device is vacuumed by a vacuum pump in a closed environment. The cover and the display panel are heated by a heating module (e.g., a heating tube disposed in the vacuum device) in the vacuum device to melt the adhesive stripe. In the vacuum environment, the adhesive stripe is melted by heating to 60° C. to 80° C., and the adhesive stripe melts and flattens under a duel action of heating and pressurization. Material of the adhesive stripe is an optical adhesive, and the optical adhesive is mixed with the first adhesive layer under the action of high temperature and high pressure, so that an edge of the cover is closely attached to an edge of the display panel. In this embodiment, the adhesive stripe is melted to form a rectangular ring. A middle portion of the rectangular ring is a vacuum region surrounded by the first adhesive layer and the optical adhesive such that the middle of the cover closely attaches to the middle of the display panel under the action of atmospheric pressure. Since the cover can fully cover the display panel, the user's operation on the cover has good sensitivity. Also, the touch area of the cover corresponds to the vacuum area. When the middle of the cover is closely attached to the middle of the display panel, the touch area of the cover is recessed, thereby effectively ensuring the signal transmission of the infrared touch panel 23.

In this embodiment, the first adhesive layer and the optical adhesive need not be disposed in the middle of the cover to ensure the close fit of the display panel and the cover. In comparison with the prior art, it can effectively save 60% to 80% of the optical adhesive material, and effectively reduce the production costs.

In a step S56, the cover and the display panel are irradiated with ultraviolet rays, so that the melted adhesive stripe is cured into a second adhesive layer, and a vacuum chamber is formed at middle portions of the first adhesive layer and the second adhesive layer. The formed vacuum chamber is like a gap. Under the action of atmospheric pressure, the cover and the display panel are closely attached together, so that a touch operation applied on the cover has good sensitivity. A shape of the melted optical adhesive of the adhesive stripe is a ring shape. A thickness of the cover attached by the optical adhesive is slightly higher than that of the cover corresponding the vacuum chamber, that is, the touch area of the cover is recessed, thereby effectively ensuring the signal transmission of the infrared touch panel 23.

In a step S57, an infrared touch panel is disposed on the non-touch area of an upper surface of the cover. The formed infrared touch display is shown in FIG. 4.

In a further embodiment, at least one light emitting unit is disposed on the non-touch area of the upper surface of the cover, and at least one light receiving unit is disposed on the non-touch area of the upper surface of the cover. A connection line of the at least one light emitting unit and the at least one light receiving unit passes through the touch area.

In a further embodiment, a plurality of light emitting units are disposed on the non-touch area. The plurality of light emitting units are disposed at two adjacent edges of the upper surface of the cover. A plurality of light receiving units are disposed on the non-touch area. The plurality of light receiving units are disposed at another two adjacent edges of the upper surface of the cover. The plurality of light emitting units and the plurality of light receiving units are arranged in one-to-one correspondence, and a connection line of each light emitting unit and a corresponding light receiving unit passes through the touch area.

According to the manufacturing method of the infrared touch display of the present disclosure, in a process of realizing a narrow bezel, a high-adhesive adhesive layer is pre-attached to the lower surface of the cover to prevent a narrow adhesive stripe made of the optical adhesive from being misaligned or falling off when it is attached to the cover, thereby preventing safety hazards and an inaccurate alignment. A small amount of the optical adhesive is used to make the cover and the display panel fit closely to achieve a vacuum attaching, which saves a lot of optical adhesive materials and reduces production costs. Also, a signal transmission performance of the infrared touch panel is further enhanced, thereby effectively improving a product yield of the display device and enhancing a product competitiveness.

The subject of the present disclosure can be manufactured and used in industry with industrial applicability.

What is claimed is:

1. An infrared touch display, comprising:
a cover comprising a touch area and a non-touch area, wherein the touch area is located at a middle of the cover and the non-touch area is located at a periphery of the cover;
a first adhesive layer attached to a lower surface of the cover and corresponding to the non-touch area, wherein the first adhesive layer comprises a liquid adhesive or a solid adhesive;
a second adhesive layer attached to a lower surface of the first adhesive layer, wherein the second adhesive layer comprises a ring-shaped solid optical adhesive, and a width of the second adhesive layer is less than or equal to a width of the first adhesive layer;
a vacuum chamber formed at middle portions of the first adhesive layer and the second adhesive layer;
a display panel attached to a lower surface of the second adhesive layer, wherein the display panel is disposed corresponding to the middle of the cover; and
an infrared touch panel disposed on the non-touch area of an upper surface of the cover.

2. The infrared touch display as claimed in claim 1, wherein the infrared touch panel comprises:
at least one light emitting unit disposed on the non-touch area of the upper surface of the cover and configured to emit an infrared light; and
at least one light receiving unit disposed on the non-touch area of the upper surface of the cover and configured to receive the infrared light;
wherein a connection line of the at least one light emitting unit and the at least one light receiving unit passes through the touch area.

3. The infrared touch display as claimed in claim 1, wherein the infrared touch panel comprises:
a plurality of light emitting units disposed on the non-touch area and disposed at two adjacent edges of the upper surface of the cover; and
a plurality of light receiving units disposed on the non-touch area and disposed at another two adjacent edges of the upper surface of the cover;
wherein the plurality of light emitting units and the plurality of light receiving units are arranged in one-to-one correspondence, and a connection line of each light emitting unit and a corresponding light receiving unit passes through the touch area.

4. An infrared touch display, comprising:
a cover comprising a touch area and a non-touch area, wherein the touch area is located at a middle of the cover and the non-touch area is located at a periphery of the cover;
a first adhesive layer attached to a lower surface of the cover and corresponding to the non-touch area;
a second adhesive layer attached to a lower surface of the first adhesive layer;
a vacuum chamber formed at middle portions of the first adhesive layer and the second adhesive layer;
a display panel attached to a lower surface of the second adhesive layer, wherein the display panel is disposed corresponding to the middle of the cover; and
an infrared touch panel disposed on the non-touch area of an upper surface of the cover.

5. The infrared touch display as claimed in claim 4, wherein the first adhesive layer comprises a liquid adhesive or a solid adhesive, the second adhesive layer comprises a solid optical adhesive, and a width of the second adhesive layer is less than or equal to a width of the first adhesive layer.

6. The infrared touch display as claimed in claim 4, wherein the second adhesive layer has a ring shape.

7. The infrared touch display as claimed in claim 4, wherein the infrared touch panel comprises:
at least one light emitting unit disposed on the non-touch area of the upper surface of the cover and configured to emit an infrared light; and
at least one light receiving unit disposed on the non-touch area of the upper surface of the cover and configured to receive the infrared light;
wherein a connection line of the at least one light emitting unit and the at least one light receiving unit passes through the touch area.

8. The infrared touch display as claimed in claim 4, wherein the infrared touch panel comprises:
a plurality of light emitting units disposed on the non-touch area and disposed at two adjacent edges of the upper surface of the cover; and
a plurality of light receiving units disposed on the non-touch area and disposed at another two adjacent edges of the upper surface of the cover;
wherein the plurality of light emitting units and the plurality of light receiving units are arranged in one-to-one correspondence, and a connection line of each light emitting unit and a corresponding light receiving unit passes through the touch area.

9. A manufacturing method of an infrared touch display, comprising following steps:
providing a cover comprising a touch area and a non-touch area, wherein the touch area is located at a middle of the cover and the non-touch area is located at a periphery of the cover;
attaching a first adhesive layer to a lower surface of the cover, wherein the first adhesive layer corresponds to the non-touch area;
cutting a solid optical adhesive into an adhesive stripe, and attaching the adhesive stripe to a lower surface of the first adhesive layer;
disposing the cover on an upper surface of a display panel such that display panel is disposed corresponding to the middle of the cover, and a lower surface of the adhesive stripe is attached to the upper surface of the display panel;
heating the cover and the display panel in a vacuum environment to melt the adhesive stripe;
irradiating the cover and the display panel with ultraviolet rays, so that the melted adhesive stripe is cured into a second adhesive layer, and a vacuum chamber is formed at middle portions of the first adhesive layer and the second adhesive layer; and
disposing an infrared touch panel on the non-touch area of an upper surface of the cover.

10. The manufacturing method as claimed in claim 9, wherein in steps of cutting the solid optical adhesive into the adhesive stripe and attaching the adhesive stripe to the lower surface of the first adhesive layer, the manufacturing method further comprises:
cutting the solid optical adhesive into four adhesive stripes;
connecting the four adhesive stripes in end-to-end relation to form a ring shape; and
attaching the ring-shaped adhesive stripes to the lower surface of the first adhesive layer.

11. The manufacturing method as claimed in claim 9, wherein in the step of heating the cover and the display panel in the vacuum environment to melt the adhesive stripe, the manufacturing method further comprises:
transferring the cover and the display panel into a vacuum device;
vacuuming the vacuum device by a vacuum pump in a closed environment; and
heating the cover and the display panel by a heating module in the vacuum device to melt the adhesive stripe.

12. The manufacturing method as claimed in claim 9, wherein in the step of disposing the infrared touch panel on the non-touch area of the upper surface of the cover, the manufacturing method further comprises:
disposing at least one light emitting unit on the non-touch area of the upper surface of the cover; and
disposing at least one light receiving unit on the non-touch area of the upper surface of the cover;
wherein a connection line of the at least one light emitting unit and the at least one light receiving unit passes through the touch area.

13. The manufacturing method as claimed in claim 9, wherein in the step of disposing the infrared touch panel on the non-touch area of the upper surface of the cover, the manufacturing method further comprises:
disposing a plurality of light emitting units on the non-touch area, wherein the plurality of light emitting units are disposed at two adjacent edges of the upper surface of the cover; and
disposing a plurality of light receiving units on the non-touch area, wherein the plurality of light receiving units are disposed at another two adjacent edges of the upper surface of the cover;
wherein the plurality of light emitting units and the plurality of light receiving units are arranged in one-to-one correspondence, and a connection line of each light emitting unit and a corresponding light receiving unit passes through the touch area.
